(19) United States
(12) Patent Application Publication
(10) Pub. No.: US 2026/0358204 A1
(43) Pub. Date: Nov. 12, 2026

(54) SYSTEMS AND METHODS FOR LIQUID-TO-LIQUID SAMPLE COLLECTION

(71) Applicant: DH Technologies Development Pte. Ltd., Singapore (SG)

(72) Inventors: Peter KOVARIK, Concord (CA); Thomas R. COVEY, Concord (CA)

(73) Assignee: DH Technologies Development Pte. Ltd., Singapore (SG)

(21) Appl. No.: 19/486,427

(22) PCT Filed: May 23, 2024
(86) PCT No.: PCT/IB2024/055023

§ 371 Date: Nov. 21, 2025

Related U.S. Application Data
(60) Provisional application No. 63/468,356, filed on May 23, 2023.

(51) Int. Cl. G01N 1/14

(52) U.S. Cl. CPC G01N 1/14; G01N 2001/1418

(57) ABSTRACT

A method of sampling with an open port interface (OPI) comprises operating the OPI. A liquid sample is contacted with the OPI. An aliquot from the liquid sample is pinned to the OPI. The aliquot includes a predetermined volume which terminates contact between the OPI and the liquid sample. The aliquot is aspirated from the OPI via a removal conduit within the OPI.

### BACKGROUND

This application is a National Stage Application of PCT/IB2024/055023, filed on May 23, 2024, which claims the benefit of U.S. Provisional Patent Application No. 63/468,356, filed May 23, 2023, the entire disclosures of which are incorporated herein by reference in their entireties. To the extent appropriate, a claim of priority is made to each of the above disclosed applications.

### BACKGROUND

Prior approaches to liquid sampling from a sample reservoir include a pipette or capillary to draw sample liquid based on aspiration. Container-based sampling employs immersion of a fixed volume into the reservoir to mechanically remove a fixed volume. Other methods include insertion of a probe, such as a SPME fibre, that attracts and couples to analytes of interest for withdrawal from the reservoir for further analysis

### SUMMARY

In one aspect, the technology relates to a method of sampling with an open port interface (OPI), the method including: operating the OPI; contacting a liquid sample with the OPI; pinning an aliquot from the liquid sample to the OPI, wherein the aliquot includes a predetermined volume; terminating contact between the OPI and the liquid sample; and aspirating the aliquot from the OPI via a removal conduit within the OPI. In an example, operating the OPI includes operating the OPI in a critical vortex mode. In another example, operating the OPI includes: delivering a transport liquid to the OPI at a first flow rate; and while delivering the transport liquid, aspirating the transport liquid from the OPI at a second flow rate greater than the first flow rate. In yet another example, the contacting the liquid sample with the OPI includes a time of contact of about 50 msec to about 300 msec. In still another example, contacting the liquid sample with the OPI includes moving the liquid sample relative to the OPI in a first direction.

In another example of the above aspect, the liquid sample is contained within at least one well of a microplate. In an example, pinning the aliquot from the liquid sample to the OPI forms an air gap between the aliquot and a transport liquid disposed in the OPI. In another example, terminating contact between the liquid sample and the OPI includes moving the liquid sample relative to the OPI in a second direction opposite the first direction. In yet another example, aspirating from the OPI the aliquot includes drawing the aliquot and at least a portion of the transport liquid into the removal conduit. In still another example, aspirating the aliquot from the OPI includes withdrawing the air gap.

In another example of the above aspect, the method further includes, subsequent to terminating contact between the liquid sample and the OPI, delivering a wash liquid to an exterior surface of the OPI.

In another aspect, the technology relates to a method of obtaining a sample aliquot from a liquid sample with an open port interface (OPI), the method includes: operating the OPI in a critical vortex mode; and contacting the liquid sample with the OPI for less than about 300 msec to obtain the sample aliquot. In an example, the sample aliquot includes a volume of about 2 μL. In another example, an OPI transport liquid in-flow rate is less than an OPI aspiration flow rate.

In another aspect, the technology relates to an open port interface (OPI) system including: an OPI including: a wash sleeve defining a central channel and including a wash liquid port fluidically coupled to the central channel; an outer housing disposed within the central channel and defining a sample inlet port and a transport liquid supply conduit, wherein the outer housing is spaced apart from the central channel; and a sample removal conduit disposed within the transport liquid supply conduit. In an example, a portion of the outer housing defining the sample inlet port is coated with a hydrophobic coating. In another example, the outer housing includes a transport liquid port fluidically coupled to the transport liquid supply conduit. In yet another example, the OPI system further includes a supply valve which includes a common liquid inlet, a wash liquid outlet, and a transport liquid outlet, wherein the wash liquid outlet is fluidically coupled to the wash liquid port and the transport liquid outlet is fluidically coupled to the transport liquid port. In still another example, the OPI system further includes a pressurized common liquid source coupled to the common liquid inlet of the supply valve.

In another example of the above aspect, the pressurized common liquid source is coupled to a piezoelectric pump.

### BRIEF DESCRIPTION OF THE DRAWINGS

FIG. 1 is a schematic view of an example system utilizing an open port interface (OPI) sampling interface and electrospray ionization (ESI) source.

FIG. 2A depicts a plot of signal peak height as a function of sampling times.

FIG. 2B depicts a plot of peak width as function of sampling time.

FIG. 2C depicts a plot of sample peaks.

FIGS. 3A-3E depict partial cross-sectional views of a system depicting a sample aliquot introduced to an OPI in a liquid-to-liquid sampling operation.

FIG. 4 depicts schematic cross-sectional view of an example of a self-washing OPI system.

FIG. 5 depicts a method of operating a mass spectrometry system.

FIGS. 5A-5C illustrate various critical flow modes for an OPI.

FIG. 6 depicts an example of a suitable operating environment in which one or more of the present examples can be implemented.

### DETAILED DESCRIPTION

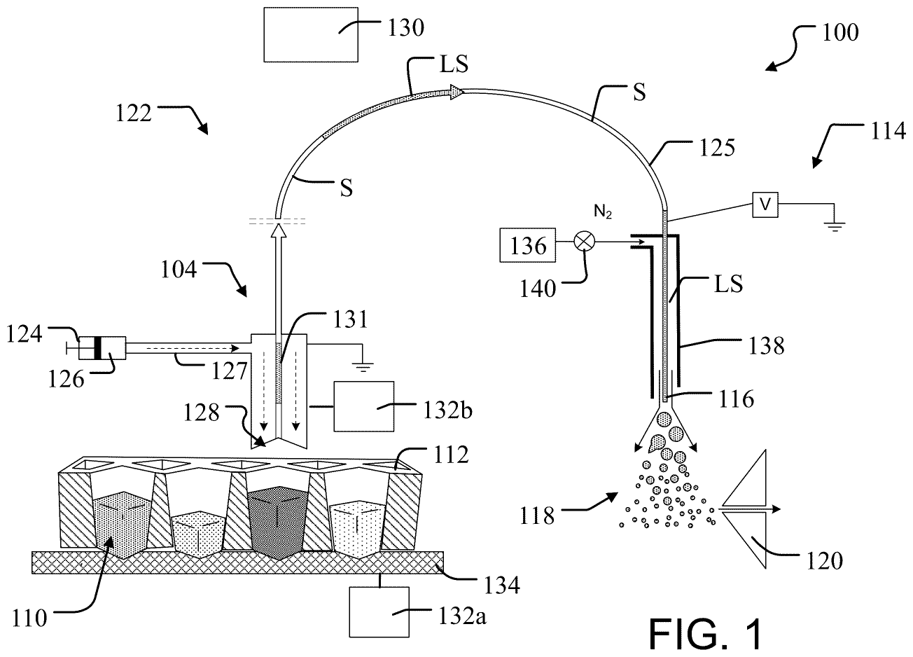

FIG. 1 is a schematic view of an example system 100 combining with an OPI sampling interface 104 and ESI source 114. The system 100 may be a mass analysis instrument such as a mass spectrometry device that is for ionizing and mass analyzing analytes received within an open end of a sampling OPI 104. Such a system 100 is described, for example, in U.S. Pat. No. 10,770,277, the disclosure of which is incorporated by reference herein in its entirety. Liquid samples are contained within individual wells 110 of a well plate 112, which may be moved via a moveable stage 134. Movement may be enabled via one or more motors or other actuators (depicted generally at 132a). Such movement may include movement of the stage 134 and well plate 112 relative to and towards the OPI 104, so as to enable contact between the OPI 104 and the liquid samples in the various wells 110, as described in further detail herein. Alternatively, or additionally, another set of motors/actuators 132b may move the OPI 104 relative to and towards the well plate 112.

As shown in FIG. 1, the example system 100 generally includes the sampling OPI 104 in liquid communication with the ESI source 114 for discharging a liquid containing one or more sample analytes (e.g., via electrospray electrode 116) into an ionization chamber 118, and a mass analyzer detector (depicted generally at 120) in communication with the ionization chamber 118 for downstream processing and/or detection of ions generated by the ESI source 114. Due to the configuration of the nebulizer probe 138 and electrospray electrode 116 of the ESI source 114, samples ejected therefrom are in a nebulized plume that desolvates to the gas phase. A liquid handling system 122 (e.g., including one or more pumps 124 and one or more transfer conduits 125) provides for the flow of liquid from a solvent reservoir 126 to the sampling OPI 104 and from the sampling OPI 104 to the ESI source 114. The solvent reservoir 126 (e.g., containing a liquid, desorption solvent) can be liquidly coupled to the sampling OPI 104 via a supply conduit 127 through which the liquid can be delivered at a selected volumetric rate by the pump 124 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. Further examples of sampling OPIs, including those that perform a washing function of the OPI between obtaining of samples from different wells, are described in more detail below.

As discussed in detail below, the flow of liquid into and out of the sampling OPI 104 occurs within a sample space accessible at the open end such that one or more sample aliquots (e.g., from one or more sample wells 110) can be introduced into the port inlet 128 at the OPI 104 tip and subsequently delivered to the ESI source 114, by being drawn first into a sample removal conduit 131 within the OPI 104. A controller 130 may be operatively coupled to the various components depicted herein. Controller 130 can be, but is not limited to, a microcontroller, a computer, a microprocessor, or any device capable of sending and receiving control signals and data. Wired or wireless connections between the controller 130 and the remaining elements of the system 100 are not depicted but would be apparent to a person of skill in the art.

As shown in FIG. 1, the ESI source 114 can include a source 136 of pressurized gas (e.g. nitrogen, air, or a noble gas) that supplies a high velocity nebulizing gas flow to the nebulizer probe 138 that surrounds the outlet end of the electrospray electrode 116. As depicted, the electrospray electrode 116 protrudes from a distal end of the nebulizer probe 138. The pressured gas interacts with the liquid discharged from the electrospray electrode 116 to enhance the formation of the sample plume and the ion release within the plume for sampling by mass analyzer detector 120, e.g., via the interaction of the high speed nebulizing flow and jet of liquid sample (e.g., analyte-solvent dilution). The liquid discharged may include discrete volumes of liquid samples LS received from each reservoir 110 of the well plate 112. The discrete volumes of liquid samples LS may be separated from each other by volumes of the solvent S (hence, as flow of the solvent moves the liquid samples LS from the OPI 104 to the ESI source 114, the solvent may also be referred to herein as a transport liquid). The nebulizer gas can be supplied at a variety of flow rates, for example, in a range from about 0.1 L/min to about 20 L/min, which can also be controlled under the influence of controller 130 (e.g., via opening and/or closing valve 140).

It will be appreciated that the flow rate of the nebulizer gas can be adjusted (e.g., under the influence of controller 130) such that the flow rate of liquid within the sampling OPI 104 can be adjusted based, for example, on suction/aspiration force generated by the interaction of the nebulizer gas and the analyte-solvent dilution as it is being discharged from the electrospray electrode 116 (e.g., due to the Venturi effect). The ionization chamber 118 can be maintained at atmospheric pressure, though in some examples, the ionization chamber 118 can be evacuated to a pressure lower than atmospheric pressure.

It will also be appreciated by a person skilled in the art and in light of the teachings herein that the mass analyzer detector 120 can have a variety of configurations. Generally, the mass analyzer detector 120 is configured to process (e.g., filter, sort, dissociate, detect, etc.) sample ions generated by the ESI source 114. By way of non-limiting example, the mass analyzer detector 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17: 1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that is disposed between the ionization chamber 118 and the mass analyzer detector 120 and is configured to separate ions based on their mobility difference under high-field and low-field conditions. Additionally, it will be appreciated that the mass analyzer detector 120 can comprise a detector that can detect the ions that pass through the analyzer detector 120 and can, for example, supply a signal indicative of the number of ions per second that are detected.

Discrete droplets of liquid samples may be introduced to the OPI using a variety of methods. In an example used in conjunction with the downward-facing OPI 104 of FIG. 1, an acoustic droplet ejector (ADE) may be used to eject individual sample droplets from wells 110 of a well plate 112. Such droplets may be very small and have volumes in the nanoliter range. In another example, the OPI may be inverted (such that the inlet port is facing upwards), and a pin tool may be utilized to introduce a sample into the OPI. Conventional pin tools incorporate a slot within a bottom portion of the pin, which may be raised, lowered, and otherwise moved from a sample reservoir to the OPI. Droplets are “pinned” (or cling) to the bottom portion of the pin, with the size of the pinned droplet dependent upon the surface condition of the pin and the dimensions of the slot. Typical usage involves touching a liquid surface of a sample with the pin tool, capturing a droplet of sample, and mechanically transferring the pinned sample over to the OPI. Thereafter, the pin must be washed to prevent cross-contamination of the various samples. In other examples, droplets may be introduced directly from a droplet ejector into an upward-facing OPI. Each of the above methods have known advantages and disadvantages.

In one aspect of the present technology, the process by which OPIs described herein operate is based on a surface tension phenomenon called pinning. Surface tension causes liquid to collect into a liquid bead (also called a droplet or an aliquot) at a solid interface such as at the portion of the OPI defining the inlet port. The angle at which the aliquot contacts the solid is called the contact angle, θ_{c}. The aliquot surface assumes a shape that is least demanding on energy due to the surface tension (e.g., the interaction with the solid surface). When an expanding or shrinking aliquot surface encounters an edge, the surface contact angle can change significantly, the energy demands of this change may force it to be pinned by the obstacle, localizing the aliquot. Volume of the removed liquid is determined by shape, geometry, and dimensions of the solid surface. Surface treatment (either by one or more of a hydrophilic coating, a hydrophobic coating, OPI material selection, electrical or mechanical surface treatment, etc.), is another design parameter of OPIs described herein that may affect the pinning functionality. By designing the OPI to work with contact angle-based sampling, the OPIs described herein combine pick up of an accurately sized sample aliquot with its removal and introduction into a transport liquid flow. The geometry of these OPIs operating at critical flows (e.g., between about 0.5 and about 0.9 of closed flow) achieves air isolation of the pinned aliquot plug from the fast-moving transport flow near center of the OPI, while pinning the aliquot over an effectively stationary transport liquid near the outer edge of the inlet port of the OPI. The aliquot volume picked up by the OPI can be altered by changing the dimensions, geometry, and surface conditions of the OPI, inlet port, etc. In an example, increasing the OPI tube diameter would increase the sampled volume, hence the OPIs designed consistently with the teachings herein obtain sample aliquots having volumes between about 2 μL to about 10 μL, significantly higher than the nanoliter-sized droplets available with systems that utilize acoustic ejection systems. Other sample sizes contemplated include between about 0.1 μL to about 10 μL, about 2 μL to about 7 μL, about 2 μL to about 5 μL, about 5 nL to about 500 nl, about 50 nL to about 500 μL, and about 500 nl to about 50 μL.

The technologies described herein utilize a novel OPI to introduce sample aliquots to a mass analysis system via direct liquid-to-liquid contact. That is, the OPI containing transport liquid is placed in contact with a liquid sample, which pins an aliquot to the OPI inlet port. Such an OPI acts as an atmospheric pressure “injector” with no moving parts. It is capable of high throughput sample cadence with high degree of accuracy and reproducibility. This method enables delivery of sample aliquot volumes comparable to that of conventional high performance liquid chromatography (HPLC) injectors. Such a configuration offers ease of use, ease of implementation, and robustness. The OPIs described herein are particularly suitable for ESI, which requires liquid delivery of sample to an ESI probe, such as described in the context of FIG. 1. The OPIs also enable sampling larger volumes of liquid, typical to conventional chromatography workflows that seek to exploit the limit of detection range of modern MS.

A sampling event includes the OPI inlet port being momentarily immersed into a sample liquid, or alternatively it touches the sample liquid surface, where the OPI inlet port acts as the injector. It has been observed that during a sampling event, peak height, peak width, and peak area remain constant for a range of OPI sampling times (e.g., time the OPI probe is in contact with the liquid sample) and independent of depth the OPI reaches during a sampling event. In these examples, about 2.5 μL may be captured and sampled. It was initially assumed that the sample volume drawn into the OPI would be directly proportional to the amount of time the OPI was in contact with (or dipped into) the liquid sample. If the OPI was running in a critical vortex mode, it was also assumed that the sample would be directly aspirated during that dip time. It has been confirmed through testing, however, that the above assumptions are incorrect within a limited time window due to, e.g.: an observed phenomenon known as “pinning”; the presence of an air gap separating the sample aliquot from the capture liquid within the OPI; and the capture liquid flow profile providing a velocity of about zero in the pinning region (e.g., the velocity gradient of capture liquid in the capture region). Remarkably, the OPI with capture liquid flowing through the capture region acts similar to a pinning tool (such as described above) for a relatively extended duration. This means that the amount of liquid sampled (or captured) is consistent between multiple sampling events and can be predicted for future sampling events. This sampling is robust across minor sampling time and sampling depth variations. It has been determined that, for dip times between 50 msec and 500 msec, the peak height, peak area, and peak width remain the same. For dip times greater than 2 sec, the peak height remains the same, but peak area (width) increases, as sampling becomes a diluted infusion experiment. Contemplated dips times for consistent performance includes 1 msec to 1000 msec, 1 msec to 750 msec, 1 msec to 300 msec, 5 msec to 500 msec, and 10 msec to 500 msec.

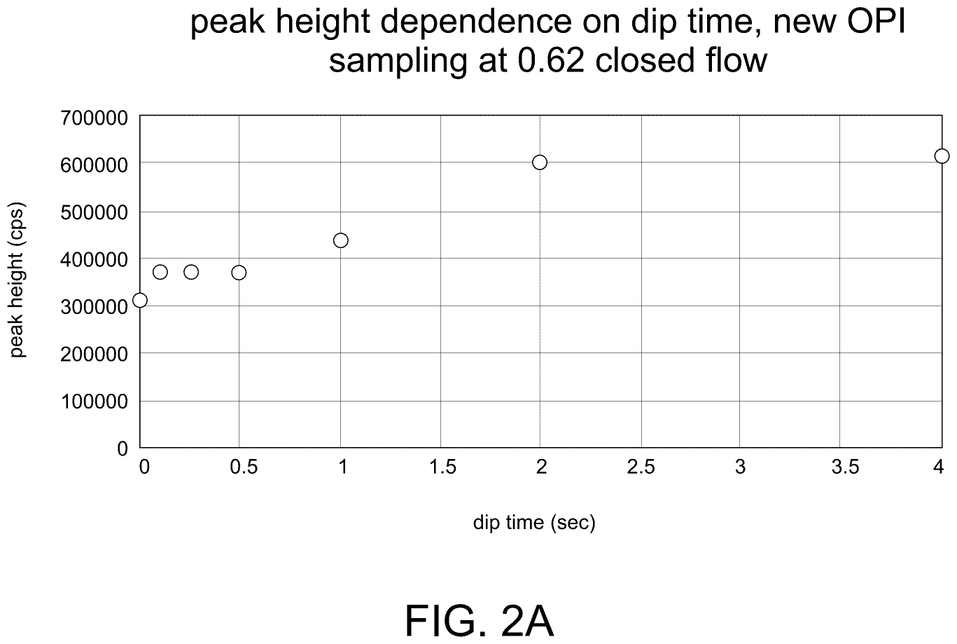

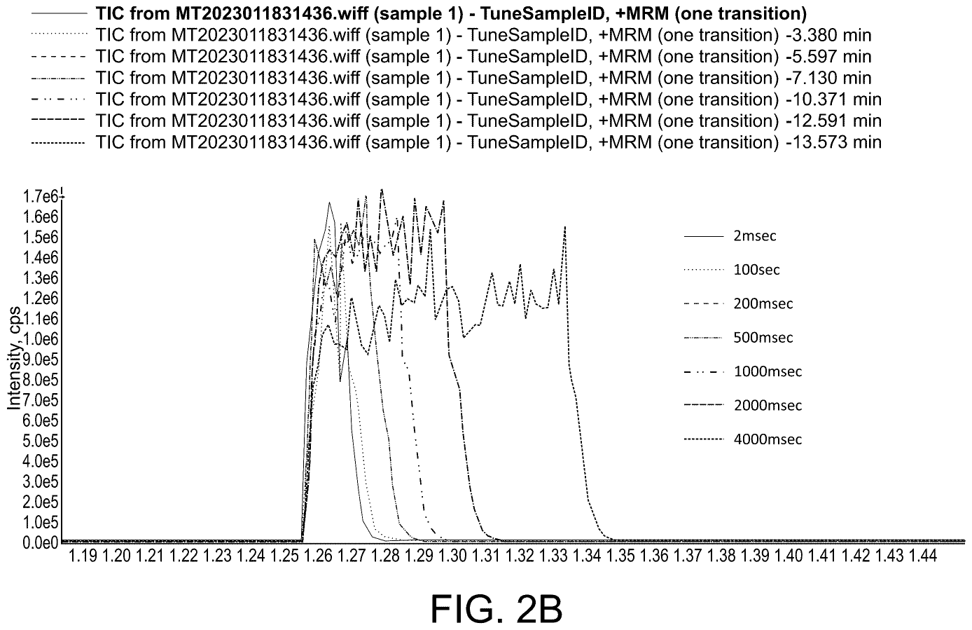

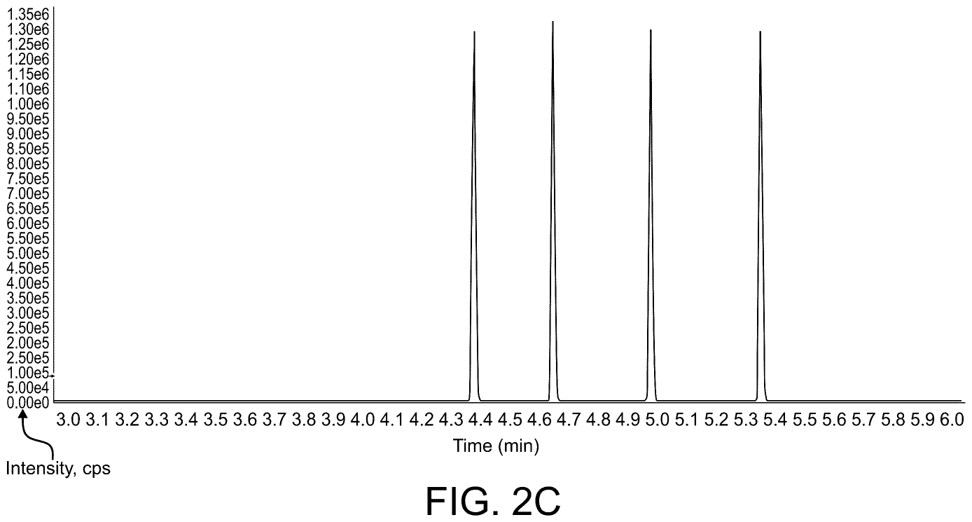

This data is depicted in FIG. 2A, which depicts a plot of signal peak height as a function of sampling times (also referred to herein as “dip” times). It takes a very brief time for the pinned sample to be drawn into contact with the capture liquid within the OPI and be drawn into the removal capillary. The data shown in FIG. 2 makes clear that sampling is independent of time within a window of about 50 msec to about 0.7 sec. These results are also independent of depth of insertion (or dipping) of the OPI into the liquid sample. As such, an OPI sampling system operating as described herein need not rely on liquid level detection, which can be often difficult to accurately measure, given the different levels and meniscus shapes of liquid samples in various wells of a microplate and the small volumes available in such wells.

FIG. 2B depicts a plot of peak width as function of sampling time. A near-constant peak width, at about 1.5 seconds at the base, is depicted for sample times of 2 msec, 100 msec, and 200 msec. Significant deviation is found at a sample time of about 500 msec and above (1000, 2000, and 4000 msec). These longer sample times mark a transition from only pinning based sampling (of the shorter times) to a combination of pinning, mixing, and aspiration. These further processes occur as an air gap (described below) initially separating the sample from the transport liquid is removed. The time of this transition would depend on shape and/or size of the OPI, the shape and/or size of the OPI inlet port, and the transport liquid flowrate.

FIG. 2C depicts a plot of sample peaks, illustrating the reproducibility of the sampling process. The depicted peaks have a width of about 1.5 sec at the base, the sampling time is 100 msec, and the transport liquid flow is at 0.80 cflow (closed flow) MeOH. Closed flow, also called balanced flow, is a condition of maximum steady state flow where the transport liquid meniscus found within an OPI is such that no transport liquid drops or overflows from the OPI. The OPIs disclosed herein enable high throughput, with capability just marginally slower than acoustic ejectors. In examples, the OPIs described herein may operate at throughput about two times slower than ADEs. This throughput reduction, however, is attendant with a significantly simpler set up and a sensitivity increase of about 1000 times, based on sample volume. Acoustic injectors, such as sold by A.B. Sciex under the brand name Echo®, deliver sample droplets of a few nanoliters in volume, while the disclosed OPIs can produce sample aliquots of a few microliters. For workflows such as the Affinity Selection Mass Spectrometry, where samples are cleaned by the affinity selection, the dilution offered by the acoustic ejector is not desirable and would be detrimental to the assay sensitivity. With the sampling process described herein that is independent of immersion depth and duration (e.g., within a range of about 150 msec, +/−100 msec), this approach removes problems caused by sample wells not being filled to the same level. As a result, no liquid surface detection is needed. The throughput of the OPI is further enhanced by fast self-washing capability, described below. This can be achieved by transport liquid flowrate variation (such as a momentary increase in transport flow above the closed flow to bead the liquid at the OPI tip) and/or by design where a dedicated wash channel is a part of the OPI. The OPIs described herein also enable fast sampling at atmospheric pressure.

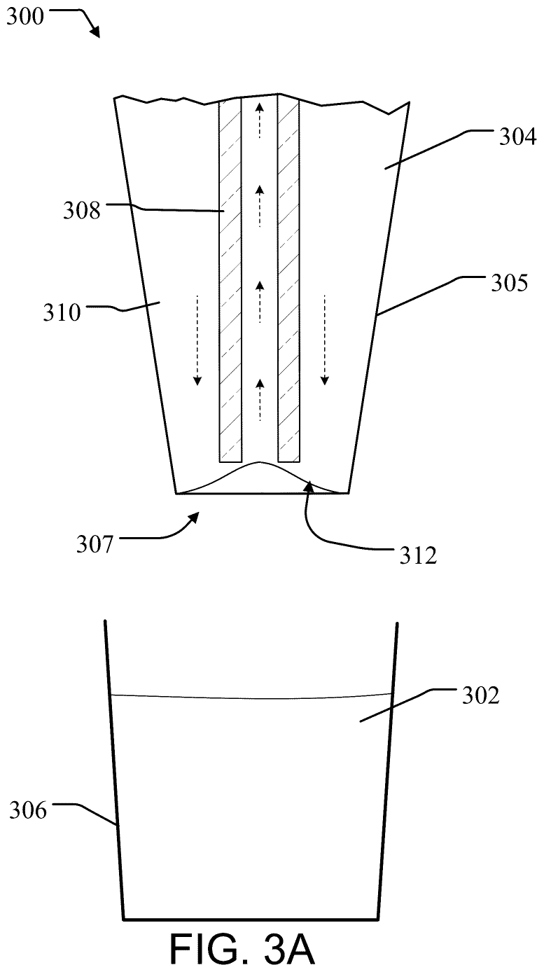

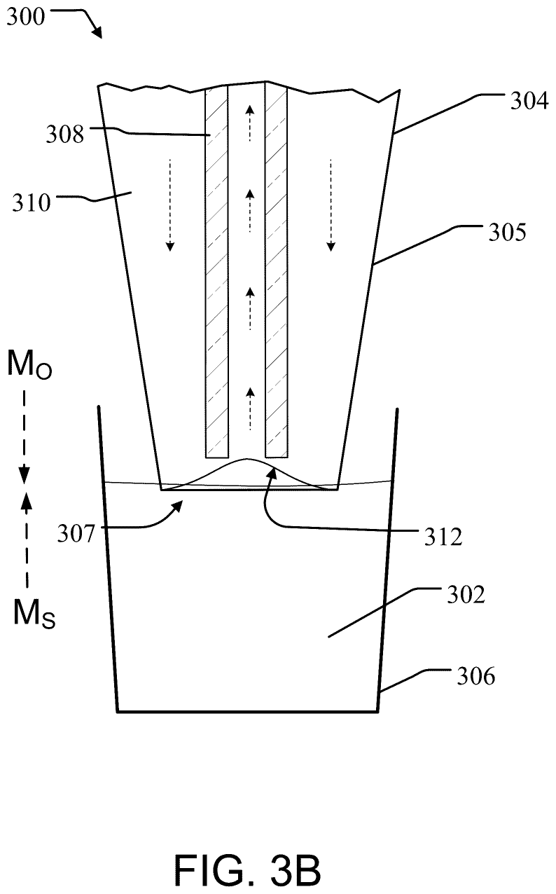

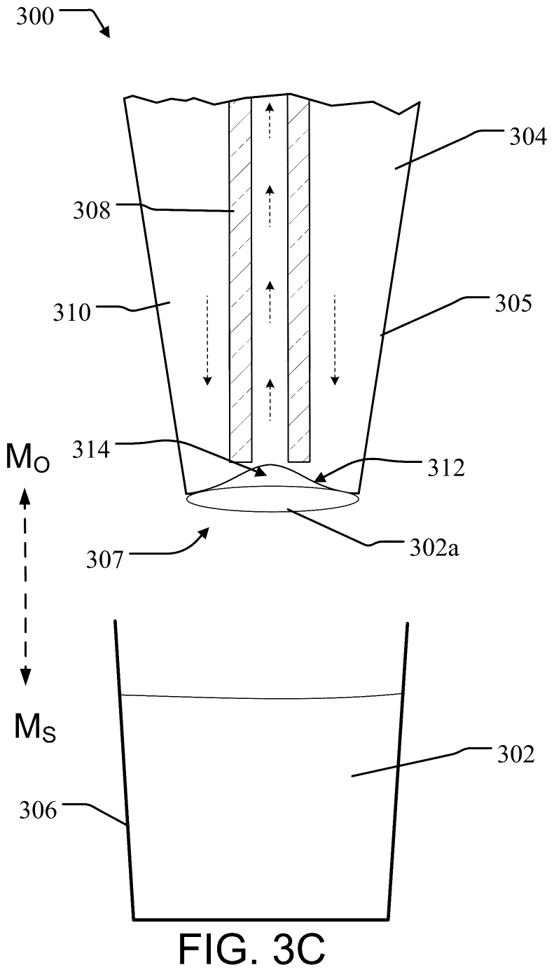

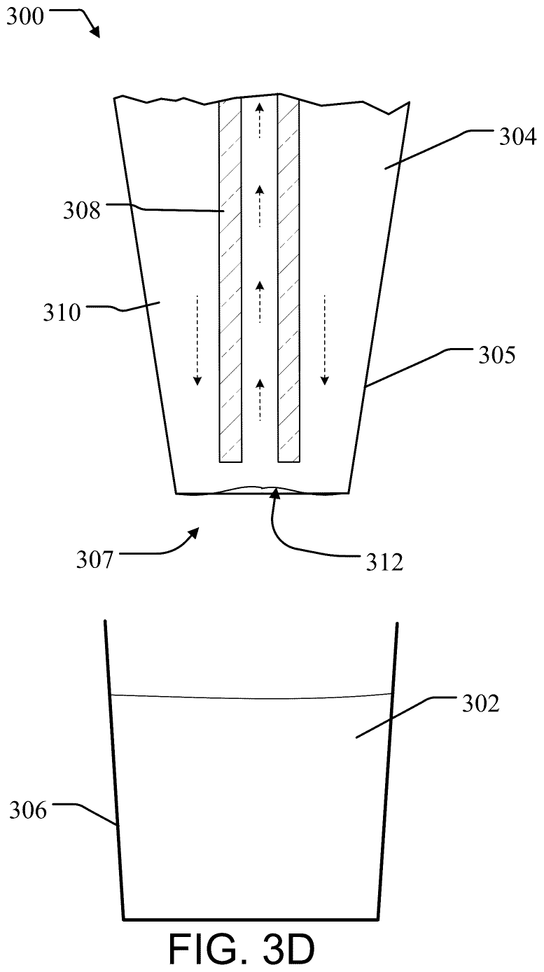

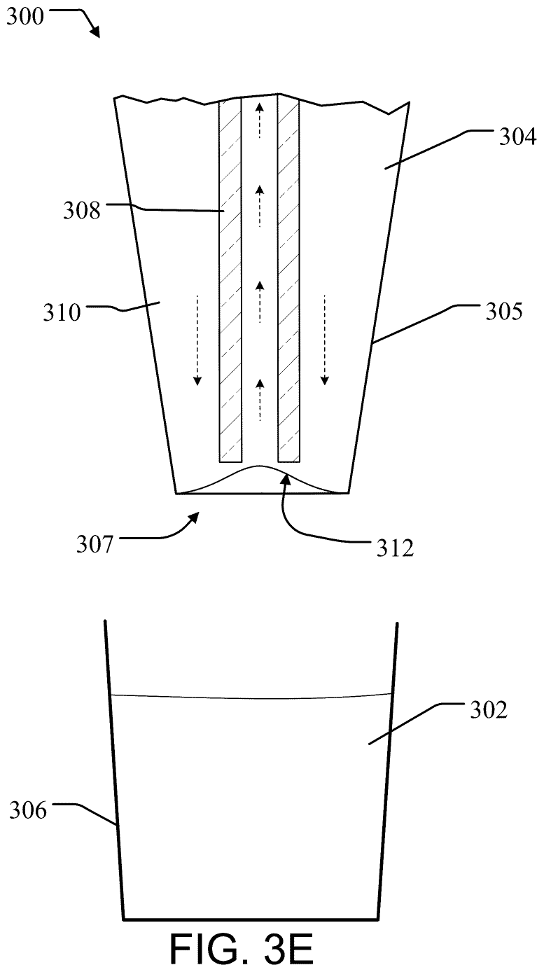

FIGS. 3A-3E depict partial cross-sectional views of a system 300 depicting a sample aliquot introduced to an OPI 304 in a liquid-to-liquid sampling operation from a liquid sample source 306 (such as a well of a well plate). The OPI 304 includes housing 305 defining at a lower end thereof an inlet port 307. The housing 305 defines therein a transport liquid supply conduit 310, in which is disposed a sample removal conduit 308. Transport liquid (depicted by dashed arrows) is delivered via the transport liquid supply conduit 310 and forms a meniscus 312 proximate the inlet 307. Thereafter, the transport liquid is aspirated into the sample removal conduit 308. The aspiration pressure draws the meniscus 312 into the sample removal conduit 308. At the appropriate balance between aspiration pressure drop and inflow liquid flow (defined in FIG. 3A by only the inflow transport liquid), the aspiration pressure deforms the meniscus 312 into a critical vortex mode, where the meniscus 312 is drawn towards the removal conduit 308. A pinning function holds the meniscus 312 closer to the edges of the inlet port 307. From the standpoint of transport liquid velocity, higher velocities are present for transport liquid closer to the removal conduit 308. At the edge of the inlet port 307, transport liquid velocities approach zero. In FIG. 3A, the liquid sample source 306 includes a liquid sample 302.

In FIG. 3B, the OPI has moved in a first direction relative to the liquid sample source 306. This movement may be movement M_{O} of the OPI 304 or may be movement M_{S} of the liquid sample source 306, or a combination of both. In FIG. 3B, the inlet port 307 contacts the liquid sample 302. As depicted in FIG. 3C, this contact pins to the edges of the housing 305 that form the inlet port 307 an aliquot 302a, obtained from the liquid sample 302. The aliquot 302a is visible as the OPI 304 is moved in a second direction relative to the liquid sample source 306. As above, the relative movement may be movement of the OPI M_{O}, movement of the sample source M_{S}, or both. Pinning of the aliquot 302a at the inlet port 307 forms an air gap 314 between the aliquot and meniscus 312, as depicted in FIG. 3C. Over a brief time, however, due to contact between the transport liquid in the OPI 310, the air gap 314 and the aliquot 302a are drawn toward the removal conduit 308. This effectively withdraws the air gap (now absent in FIG. 3D) via removing, pumping, or dissolving the air within the combination of the aliquot and transport liquid being aspirated from the removal conduit 308 and repositions the meniscus 312 closer to the inlet port 307. In FIG. 3E, the critical vortex mode of the meniscus 312 has returned, as the aliquot has been completely removed from the OPI and another sampling operation may be performed. Notably, a wash operation may be performed at this time, as described in more detail below.

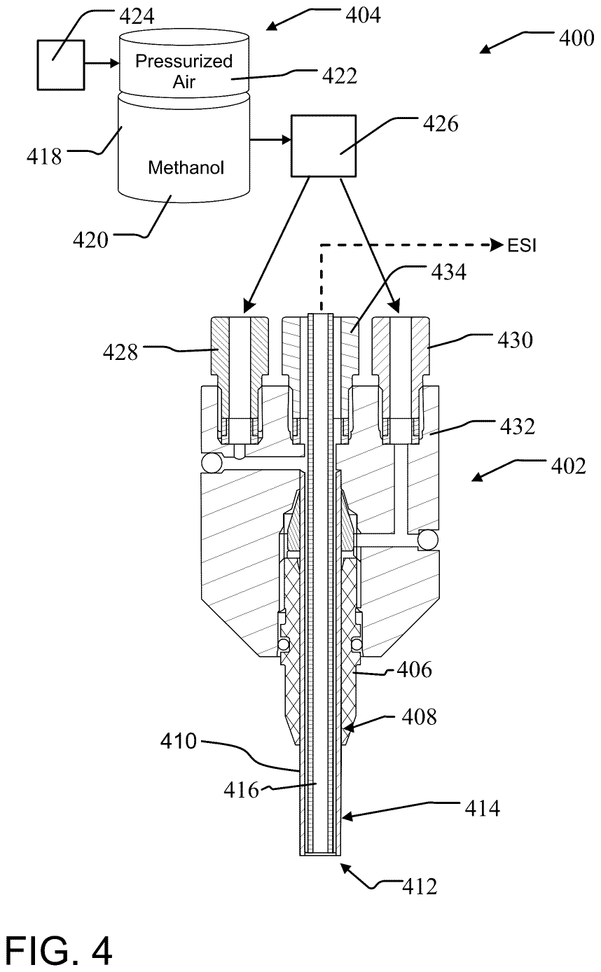

FIG. 4 depicts schematic cross-sectional view of an example of a self-washing OPI system 400. The system 400 includes a wash OPI 402 and a wash system 404. The wash OPI 402 may include a wash sleeve 406 that defines a central channel 408, which has a central channel diameter. An OPI outer housing 410 is disposed within the central channel 408 and defines an outer housing diameter less than the central channel diameter. In examples, the difference between the outer housing diameter and the central channel diameter may be such that the outer housing 410 is spaced apart from a wall of the central channel 408. This allows wash liquid to flow from the wash sleeve 406 and down around the outer housing 410, as described in more detail below. The outer housing 410 of FIG. 4 corresponds to the housing 305 such as depicted in FIGS. 3A-3E. As such, the outer housing 410 defines an inlet port 412 at a bottom end thereof, and defines a transport liquid supply conduit 414 therein. Within the transport liquid supply conduit 414 is a removal conduit 416. The outer housing 410 may have a diameter and form factor that enable the tip thereof to be inserted into a well of a well plate or other liquid sample reservoir, such as described herein.

The wash system 404 includes a source 418 of wash/transport liquid 420. In the depicted example, the wash/transport liquid 420 is methanol in a common source 418. In other examples, a dedicated wash liquid source may be discrete from a dedicated transport liquid source. The source 418 is charged with pressurized air 422 from a pressure-generating component 424 such as a piezoelectric motor. Other pressure-generating components are contemplated, such as a piston-driven pump typically used to high performance liquid chromatography (HPLC). When a common source 418 is utilized, a dual-outlet, single-inlet valve, such as a fast solenoid valve 426 may be utilized to control flow of liquid from the common source 418 to either a transport liquid head 428 or a wash liquid head 430 of a flow manifold 432. The transport liquid head 428 is fluidically coupled to a transport liquid supply port of the OPI 402, which is fluidically coupled to the transport liquid supply conduit 414 in outer housing 410 the OPI 402. The wash liquid head 430 is fluidically coupled to a wash liquid supply port of the OPI 402 (e.g., defined by the wash sleeve 406), which is fluidically coupled to the central channel 408 in the OPI 402. A third head 434, which fluidically couples the removal conduit 416 to the ESI (as described, e.g., in the context of FIG. 1) is also present in the manifold 432.

Thus, in use, the self-washing OPI system 400 enables delivery of transport liquid 420 via the transport liquid head 428 to the transport liquid supply conduit 414 within the OPI, so as to capture aliquots obtained from liquid samples, as described elsewhere herein. Between sampling events, wash liquid 420 may be delivered to the central channel 408 of the wash sleeve 406, where it flows along the outer housing 410 of the OPI 402 before being discharged from the OPI 402, for example, and into a wash fluid capture reservoir or waste container (not shown).

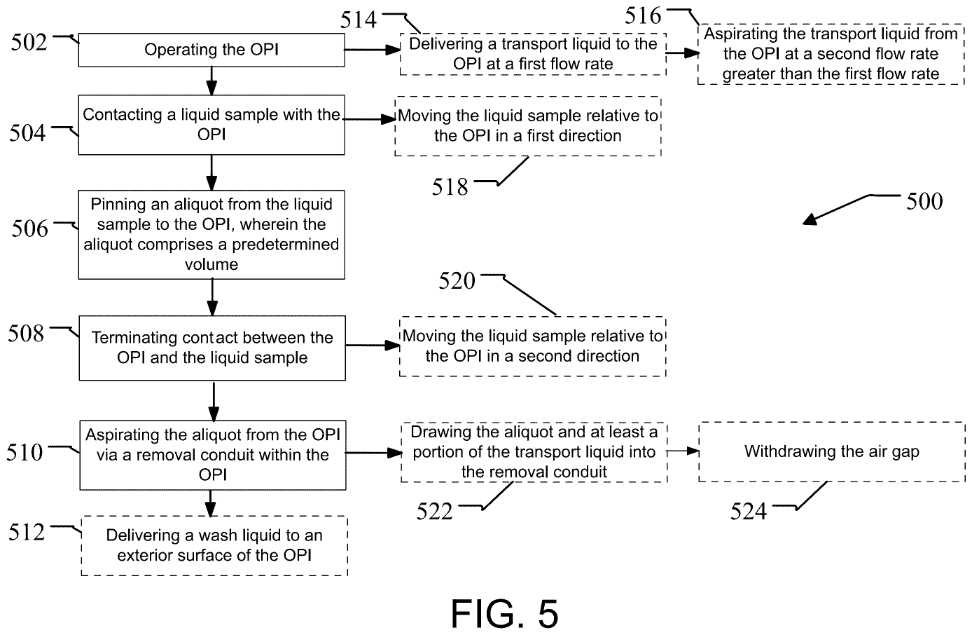

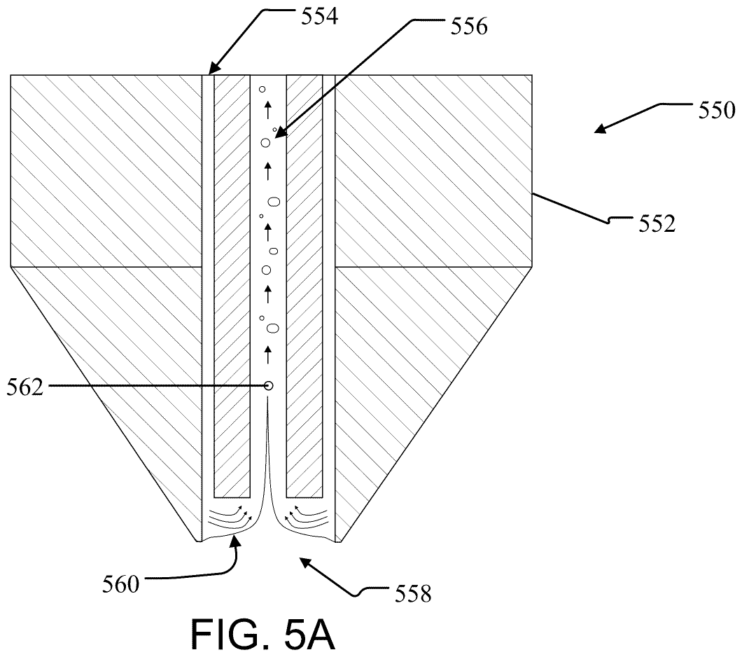

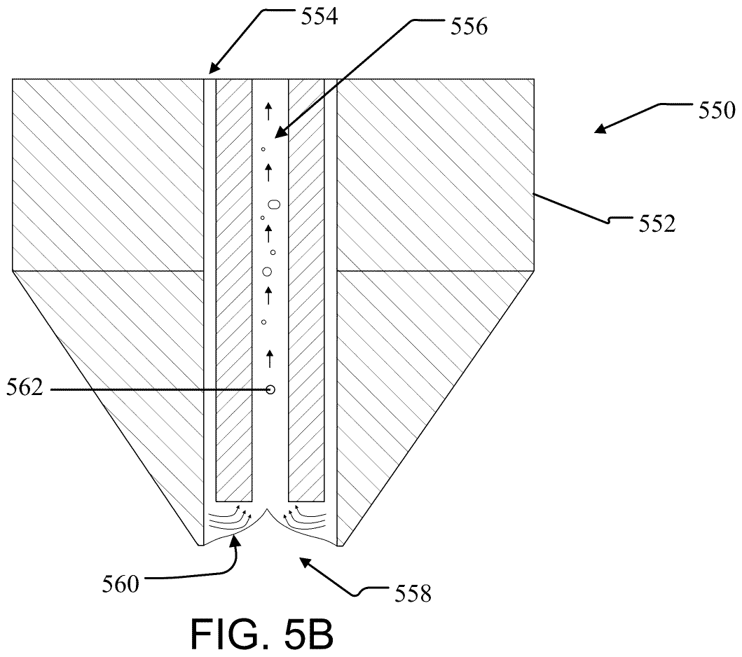

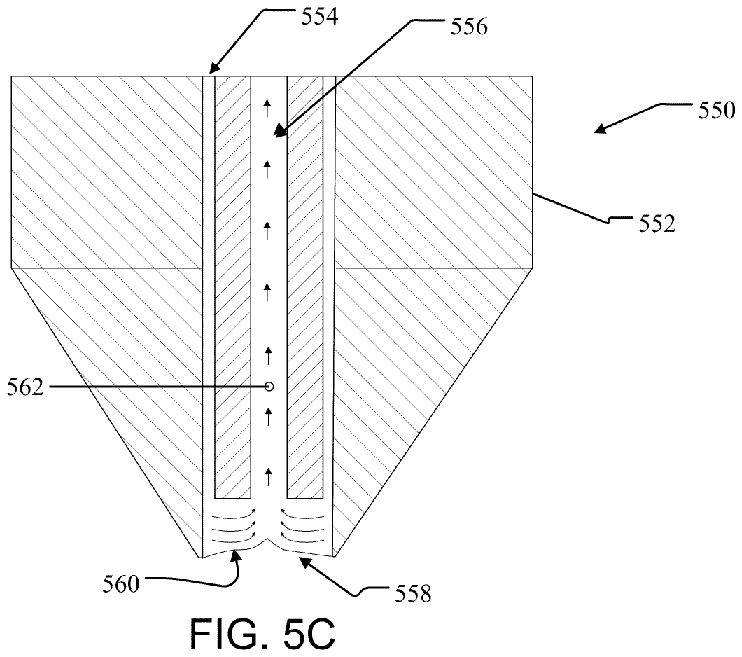

FIG. 5 depicts a method 500 of operating a mass spectrometry system. Example mass spectrometry systems, as well as components thereof, such as variously-configured OPIs, self-washing OPIs, OPI washing subsystems, etc., are described therein. The method begins with operation 502, operating the OPI, the parameters of which are described in more detail below. During operation of the OPI, a sample liquid is contacted with the OPI, operation 504. This contact causes pinning of an aliquot from the liquid sample to the OPI, operation 506. The aliquot comprises a predetermined volume, for example, 2 μL to 10 μL depending on the dimensions of the inlet port of the OPI, liquid sample viscosity, material coating or surface treatment of the OPI, etc. In operation 508, contact is terminated between the OPI and the liquid sample. Thereafter, aspirating the aliquot from the OPI via a removal conduit within the OPI is performed, operation 510. In an optional operation 512, the method 500 may include delivering a wash liquid to an exterior surface of the OPI.

The above method may be further defined by one or more of the following operations. For example, operation 502 may include operating the OPI in the critical vortex mode. This critical vortex mode may be achieved by operating the OPI in particular conditions. For example, operation 514, includes delivering a transport liquid to the OPI at a first flow rate, and operation 516, includes aspirating the transport liquid from the OPI at a second flow rate greater than the first flow rate. The difference between the first flow rate and the second flow rate forms a vortexed transport liquid meniscus within the OPI, thus achieving the critical vortex mode. Various differences between the first and second flow rates are contemplated. For example, delivering transport liquid at a first flow rate between about 5% to about 95% of a removal rate, or where rate of delivery is between 50% and 80% of the removal rate is contemplated. The removal rate is defined by the constant pressure drop at the ESI end of the removal conduit 416, as generated by the Venturi effect of the nebulizer gas. With no limit on transport liquid supply, e.g., the OPI port is filled or overflowing, this pressure drop would generate a flowrate through the removal conduit 416 that is called balanced flow or closed flow (e.g., closed flow means the removal conduit is completely filled with only the transport liquid with no air ingest). Other factors, such as transport liquid viscosity, OPI dimensions, OPI material selection, etc. may also be adjusted to achieve the critical vortex mode.

FIGS. 5A-5C illustrate various critical flow modes for an OPI 550. These modes include a super-critical mode (FIG. 5A), a critical mode (FIG. 5B), and a sub-critical mode (FIG. 5C), each of which being referred to generally as “critical vortex modes.” Each OPI 550 depicted includes an outer housing 552 that defines a transport liquid conduit 554 therein. Within the housing 552 is a removal conduit 556 out of which transport liquid and samples are drawn to an ESI, as described elsewhere herein. The outer housing 552 also defines an inlet port 558. The flow modes depicted in the figures are applicable to the technologies described herein (e.g., the aliquot pinning operations described may be performed by OPIs operating in super-critical, critical, and sub-critical modes). By operating in any of these critical modes, pinning of the sample aliquots occurs at the portion of the housing 552 defining the inlet port 558. In general, when operating in a critical vortex mode (e.g., any of the depicted super-critical, critical, and sub-critical modes), the meniscus 560 of the transport liquid 562 flowing within the OPI is draw towards (or in some cases, into) the removal conduit 556. This shaped meniscus 560 may be characterized by fairly slow flow (approximately 0) adjacent the edges of the inlet port 558, with higher flow rates of transport liquid 562 closer to (and even within) the removal conduit 556. Depending on the configuration, dimensions, etc., of the OPI and the features thereof, the flowrates generating the vortex modes will vary. In one example, where the closed flow is 425 μL/min, transport liquid flow rates into the OPI 550 of about 75-125 μL/min are contemplated for the super-critical flow condition. Transport liquid flow rates of about 175-275 μL/min are contemplated for the critical flow condition, while transport liquid flow rates of about 275-375 μL/min are contemplated for a sub-critical flow condition. Other flow rates appropriate to obtain a critical flow mode, depending on the various factors as described herein and as known in the art, are also contemplated.

Returning to FIG. 5, in operation 518, moving the liquid sample relative to the OPI in a first direction, enables contact between the liquid sample and the OPI. Moving the liquid sample relative to the OPI in a second direction opposite the first direction, operation 520, is one contemplated way to terminate contact between the liquid sample and the OPI. During operation 510, the aliquot and at least a portion of the transport liquid may be drawn into the removal conduit of the OPI, operation 522. In examples, this withdraws the air gap that had previously been present in the OPI, operation 524.

With regard to washing operation 512, alternative or additional operations may be performed to wash the OPI, rather than delivering wash liquid to an exterior surface thereof. For example, by increasing the supply flow rate of the transport liquid into the transport liquid supply conduit, a distended droplet of transport liquid is formed at the tip to wash the portion of the OPI that defines the inlet port. Pinning of that distended droplet allows the droplet to wash the portion of the OPI disposed about the inlet port, which may be flat or disposed at an angle. The contour of the transport liquid in the OPI also coats the interior wall of the outer housing to prevent carryover from sample to sample. Either oversupply of capture liquid or washing by flushing wash liquid through a wash conduit may be utilized to clean and wash the outer housing of the OPI. Test data indicates sample carryover without washing is less than about 1%. As such, washing is a useful optional feature of the OPIs described herein, but is not required to achieve statistically relevant results. The wash liquid may be allowed to separate to a waste port or may be aspirated back into the transport liquid flow through appropriate control of the transport flow supply. Similarly, wash liquid supplied by the wash channel 408 may also be allowed to drip to waste or be aspirated into the transport liquid flow.

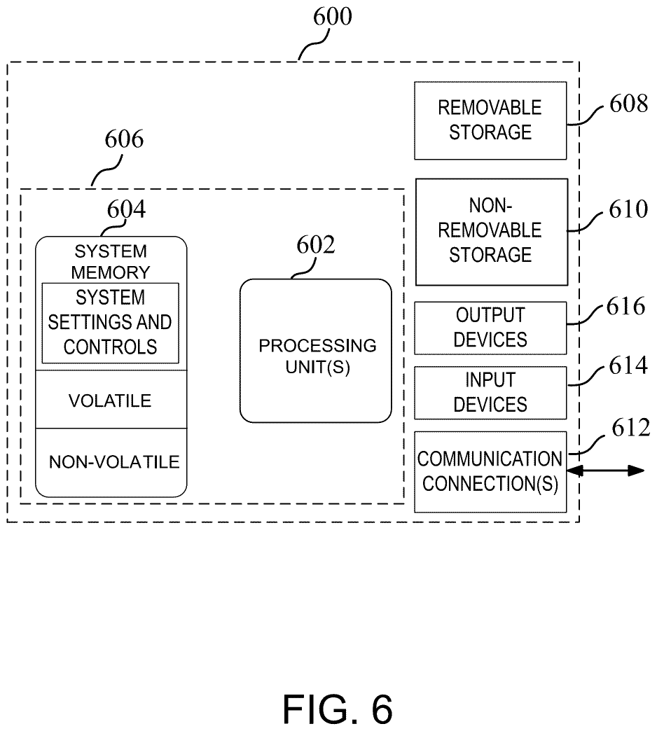

FIG. 6 depicts one example of a suitable operating environment 600 in which one or more of the present examples can be implemented. This operating environment may be incorporated directly into the controller for a mass spectrometry system, e.g., such as the controller depicted in FIG. 1. This is only one example of a suitable operating environment and is not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, tablets, distributed computing environments that include any of the above systems or devices, and the like.

In its most basic configuration, operating environment 600 typically includes at least one processing unit 602 and memory 604. Depending on the exact configuration and type of computing device, memory 604 (storing, among other things, instructions to adjust an aspiration pressure or transport liquid flow rate, initiate a wash process, or perform other methods disclosed herein) can be volatile (such as RAM), non-volatile (such as ROM, flash memory, etc.), or some combination of the two. This most basic configuration is illustrated in FIG. 6 by dashed line 606. Further, environment 600 can also include storage devices (removable, 608, and/or non-removable, 610) including, but not limited to, magnetic or optical disks or tape. Similarly, environment 600 can also have input device(s) 614 such as touch screens, keyboard, mouse, pen, voice input, etc., and/or output device(s) 616 such as a display, speakers, printer, etc. Also included in the environment can be one or more communication connections 612, such as LAN, WAN, point to point, Bluetooth, RF, etc.

Operating environment 600 typically includes at least some form of computer readable media. Computer readable media can be any available media that can be accessed by processing unit 602 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The operating environment 600 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by computer system 600 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some examples, computer system 600 is part of a network that stores data in remote storage media for use by the computer system 600.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

1. A method of sampling with an open port interface (OPI), the method comprising:
operating the OPI;
contacting a liquid sample with the OPI;
pinning an aliquot from the liquid sample to the OPI, wherein the aliquot comprises a predetermined volume;
terminating contact between the OPI and the liquid sample; and
aspirating the aliquot from the OPI via a removal conduit within the OPI.

2. The method of claim 1, wherein operating the OPI comprises operating the OPI in a critical vortex mode.

3. The method of claim 1, wherein operating the OPI comprises:
delivering a transport liquid to the OPI at a first flow rate; and
while delivering the transport liquid, aspirating the transport liquid from the OPI at a second flow rate greater than the first flow rate.

4. The method of claim 1, wherein the contacting the liquid sample with the OPI comprises a time of contact of about 50 msec to about 300 msec.

5. The method of claim 1, wherein contacting the liquid sample with the OPI comprises moving the liquid sample relative to the OPI in a first direction.

6. The method of claim 1, wherein the liquid sample is contained within at least one well of a microplate.

7. The method of claim 1, wherein pinning the aliquot from the liquid sample to the OPI forms an air gap between the aliquot and a transport liquid disposed in the OPI.

8. The method of claim 1, wherein terminating contact between the liquid sample and the OPI comprises moving the liquid sample relative to the OPI in a second direction opposite the first direction.

9. The method of claim 7, wherein aspirating from the OPI the aliquot comprises drawing the aliquot and at least a portion of the transport liquid into the removal conduit.

10. The method of claim 7, wherein aspirating the aliquot from the OPI comprises withdrawing the air gap.

11. The method of claim 1, further comprising, subsequent to terminating contact between the liquid sample and the OPI, delivering a wash liquid to an exterior surface of the OPI.

12. A method of obtaining a sample aliquot from a liquid sample with an open port interface (OPI), the method comprising:
operating the OPI in a critical vortex mode; and
contacting the liquid sample with the OPI for less than about 300 msec to obtain the sample aliquot.

13. The method of claim 12, wherein the sample aliquot comprises a volume of about 2 μL.

14. The method of claim 12, wherein an OPI transport liquid in-flow rate is less than an OPI aspiration flow rate.

15. An open port interface (OPI) system comprising:
an OPI comprising:
a wash sleeve defining a central channel and comprising a wash liquid port fluidically coupled to the central channel;
an outer housing disposed within the central channel and defining a sample inlet port and a transport liquid supply conduit, wherein the outer housing is spaced apart from the central channel; and
a sample removal conduit disposed within the transport liquid supply conduit.

16. The OPI system of claim 15, wherein a portion of the outer housing defining the sample inlet port is coated with a hydrophobic coating.

17. The OPI system of claim 15, wherein the outer housing comprises a transport liquid port fluidically coupled to the transport liquid supply conduit.

18. The OPI system of claim 17, further comprising a supply valve comprising a common liquid inlet, a wash liquid outlet, and a transport liquid outlet, wherein the wash liquid outlet is fluidically coupled to the wash liquid port and the transport liquid outlet is fluidically coupled to the transport liquid port.

19. The OPI system of claim 18, further comprising a pressurized common liquid source coupled to the common liquid inlet of the supply valve.

20. The OPI system of claim 19, wherein the pressurized common liquid source is coupled to a piezoelectric pump.
